(19) United States
(12) Patent Application Publication
(10) Pub. No.: US 2011/0318242 A1
(43) Pub. Date: Dec. 29, 2011

(54) METERING DEVICE SUITED FOR METERING VERY SMALL METERING VOLUMES AND METERING METHOD

(75) Inventor: Renato Nay, Maesin (CH)

(73) Assignee: HAMILTON BONADUZ AG, Bonaduz (CH)

(21) Appl. No.: 13/131,897

(22) PCT Filed: Nov. 28, 2008
(86) PCT No.: PCT/EP2008/010126

§ 371 Date: Sep. 14, 2011

(51) Int. Cl. B01L 3/00

(52) U.S. Cl. 422/501

(57) ABSTRACT

A metering device for the aspiration and dispensing of a metered medium (26) by means of a working substance through a metering opening (22a) into a metering chamber (24), and out of the same, comprises a working chamber (12) filled at least partially with a compressible working substance, a pressure change apparatus (14, 16) which is designed to change the pressure of the working substance in the working chamber, and a metering chamber (24) comprising the metering opening (22a), wherein the working chamber (12) and the metering chamber (24) are connected by a valve (28) which can be switched between a blocking position, in which pressure transmission, in particular a working substance flow, from the working chamber (12) into the metering chamber (24) by way of the valve (28) is prevented, and a passage position, in which pressure transmission from the working chamber (12) into the metering chamber (24) by way of the valve (28) is permitted.

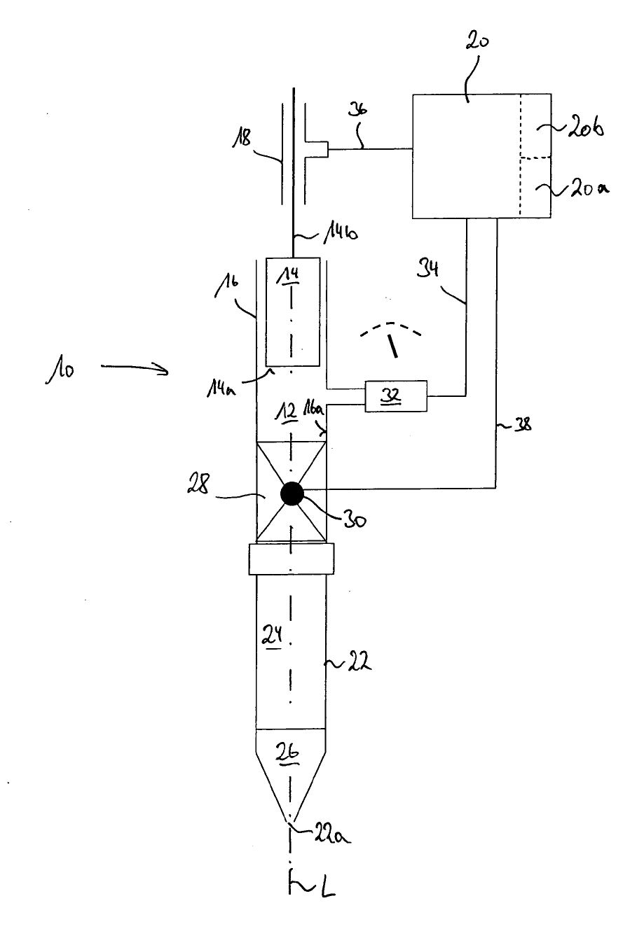

The present invention relates to a metering device for aspirating and dispensing a metering medium by means of a working medium through a metering opening into a metering chamber and out of said chamber, comprising a working chamber filled at least partially with a compressible working medium, a pressure change apparatus which is designed to change the pressure of the working medium in the working chamber, and the metering chamber comprising the metering opening.

In addition the present invention relates to a metering method for aspirating and dispensing a metering medium by means of a working medium through a metering opening into a metering chamber and out of the latter, comprising the following method step: influencing the pressure of the working medium in the metering chamber relative to the ambient pressure outside the metering chamber.

Such metering devices and metering methods are generally known in the prior art. The so-called pipetting apparatuses form a generic category of known metering devices.

With such metering devices and metering methods a metering medium to be metered is aspirated in a manner known per se via pressure reduction in the working chamber through a metering opening into a metering chamber, where it is then optionally held and is dispensed via a pressure increase in the working chamber from the metering chamber through the metering opening.

The pressure changes of the working medium in the working chamber take place relative to the pressure of the atmosphere surrounding the metering opening and the metering medium.

In simple metering devices the working chamber and the metering chamber can be identical or can coincide at least sectionally.

A disadvantage of known metering devices is the associated difficulty of aspirating and/or dispensing very small metering volumes of a metering medium in relation to the maximum possible metering volume.

This disadvantage is basically due to the construction of the known metering devices in combination with the material properties of the air that is normally used as working medium: as a rule the pressure of the working medium in the working chamber is altered by the movement of a piston in a piston-cylinder arrangement at least partially defining the working chamber. Metering volumes that are small or very small in relation to the maximum possible metering volume require very small piston movements in relation to the maximum possible piston stroke, which on account of the spring-damper action of air or in general gas as a working medium and the inertia of the as a rule liquid metering medium means that the desired small metering volumes can be metered only very inaccurately, which is the very reason why attempts to aspirate and/or dispense small and very small metering volumes lead to considerable metering errors and even a complete failure of the metering.

The object of the present invention is therefore to provide a technical teaching by means of which it is possible to meter more accurately than in the prior art small and very small metering volumes in relation to the maximum possible metering volume.

This object is achieved according to a first aspect of the present invention by a generic metering device, in which the working chamber and the metering chamber are connected via a valve that can be switched between a blocking position, in which a pressure transmission from the working chamber via the valve to the metering chamber is prevented, and a passage position, in which a pressure transmission from the working chamber via the valve to the metering chamber is permitted. By means of the solution according to the invention a predetermined pressure of the working medium in the working chamber can then be generated and/or maintained by the pressure change apparatus in the said working chamber when the valve is in the blocking position. It is advantageous in this connection that the pressure level of the working medium that is actually thereby generated can exceed the pressure level, governed by the type of construction, that is required for aspirating and/or dispensing a predetermined metering volume, in other words a greater reduced pressure than is necessary for aspirating the predetermined metering volume or a greater excess pressure than is necessary for dispensing the predetermined metering volume can prevail in the working chamber.

As a result of opening the valve and the associated pressure transmission the pressure prevailing in the working chamber can be allowed to act on the metering chamber, whereby the desired metering procedure can be executed.

The adjustability of the valve between the blocking position and the passage position ensures that the action of the pressure of the working chamber on the metering chamber can take place in a manner that is sufficient for the desired aspiration and/or dispensing of small and very small metering volumes.

Above all, the adjustable valve envisaged according to the invention allows the generation of pressure surges from the working chamber into the metering chamber, in other words a time-limited action of the pressure in the working chamber on the pressure in the metering chamber. These can be reduced pressure surges or excess pressure surges.

Depending on the duration of the pressure surge, variously large metering volumes can be aspirated and/or dispensed, which however are still always significantly smaller than if the pressure level of the working medium prevailing during of the pressure surge in the working chamber acted for an unlimited time in the metering chamber and thus on the metering medium.

Depending on the metering state of the metering device the metering chamber is as a rule likewise partially filled with a compressible working medium. This can be and is as a rule the same working medium as in the working chamber. It should not be excluded however that the metering chamber can contain a working medium different to that of the working chamber.

Whenever the present invention refers to a “compressible working medium”, this means that a not simply negligible change in volume of the working medium leads to a pressure change in the latter. Working media are as a rule gases, if possible air for reasons of cost. Water or oil are regarded as incompressible in the context of the present invention.

A pressure transmission between the working chamber and the metering chamber is as a rule accomplished most easily by a flow of working medium through the valve. In technically justified cases however it is also possible for the working chamber to be separated from the metering chamber by a membrane or the like, and for the valve to allow or prevent a membrane movement depending on its position for pressure transmission. It is also intended that such a pressure transmission is covered by the present application.

In principle it may be envisaged that the pressure change apparatus is formed by a continuously operating pump, whose pressure and/or suction side communicates with the working chamber.

In a particularly preferred case, which can be structurally realised simply with little installation space and which a person skilled in the art is familiar with through years of experience, the pressure change apparatus is however a piston-cylinder arrangement. In this case the installation space required for forming the metering device can be kept particularly small if a piston surface and a cylinder wall of the piston-cylinder arrangement demarcate the working space at least sectionally.

In most of the metering devices used nowadays the metering medium to be metered is as a rule aspirated into a pipetting tip and dispensed from the latter. It may then preferably be envisaged that the metering space is bounded at least sectionally by a wall of a pipetting tip. For reasons of adaptability of the metering device to various metering tasks, the pipetting tip is preferably detachably provided on the metering device. For the same reasons and in particular for reasons of stricter hygiene requirements, the pipetting tip is particularly preferably exchangeable, i.e. a pipetting tip is provided on the metering device which pipetting tip can be replaced by another.

To facilitate the connection of a pipetting tip to the metering device it can be envisaged in a manner known per se that the piston-cylinder arrangement is provided with a coupling arrangement to which a coupling counter-arrangement provided on the pipetting tip can be detachably coupled. Then, in order to achieve as small an installation space as possible for the metering device, it may furthermore be envisaged that the piston-cylinder arrangement has in the region of the coupling arrangement a working medium passage, in which case the valve can then be provided on said working medium passage. Advantageously the valve is then likewise located in the region of the coupling arrangement, so that the coupling of the piston-cylinder arrangement to a pipetting tip and the pressure transmission separation of the working chamber and metering chamber can be implemented in the region of the coupling arrangement, so that there is a spatially relatively small region in which the functions mentioned above are realised.

The working medium passage can as regards its length and cross-section be suitably adapted to requirements, and can in an extreme case be formed simply by an opening in which the valve is then preferably inserted. In the case of a relatively long working medium passage the functional capability of the metering device according to the invention can be reliably ensured in a constricted installation space if the working medium passage comprises a first orifice terminating in the working chamber and a second orifice lying more remote from the working chamber, a longitudinal end region of the working medium passage comprising the second orifice preferably being surrounded at least by a section of the coupling arrangement. Then, if a section of the coupling arrangement surrounds a longitudinal end region, comprising the second orifice of the working medium passage, thereof, this ensures that the working chamber can be reliably brought into pressure transmission communication with a metering chamber bounded at least sectionally by a pipetting tip.

A structural arrangement of the metering device according to the invention that can again be realised with small spatial requirements can be achieved if the valve is arranged spatially between the piston of the piston-cylinder arrangement and the metering opening. Preferably in this case the metering opening is located in an extension of the movement path of the piston, so that the imaginary extended movement path passes through the metering opening. In this way a very thin metering device is obtained. This enables several metering devices to be arranged parallel to one another in a constricted space.

Specifically when the metering procedure described above is to be automated or at least operationally assisted, it is advantageous if the pressure change apparatus comprises a pressure change actuator that is coupled to the pressure change apparatus in order to change the pressure of the working medium in the working chamber. In the above-mentioned example of a piston-cylinder arrangement a pressure change actuator may for example be a servomotor moving the piston relative to the cylinder. If the pressure change apparatus comprises a continuous operation in the pump, then the pressure change actuator may be a motor driving the pump.

Furthermore in this connection it is advantageous if the pressure change apparatus comprises a first control device that is designed to control the pressure change actuator. The pressure of the working medium in the working chamber can then be changed by the first control device via the pressure change actuator.

Likewise, in order to automate a metering procedure or at least provide mechanical support for the operation of the latter the metering device can comprise a valve actuator coupled to the valve for the adjustment thereof, and a second control device that is designed to control the valve actuator.

If it is desired to control a metering procedure by means of a control circuit, or if in principle a metering procedure with a particularly high accuracy is desired, then it is desirable if the metering device comprises a pressure detection device that is designed and arranged so as to detect the pressure of the working medium in the working chamber. A control circuit can in particular be implemented by the first control device being designed to control the pressure change actuator depending on the pressure detection result of the pressure detection device, in particular being designed to generate and/or maintain a pre-set pressure of the working medium in the working chamber.

Furthermore, the metering device can comprise a timing device, which can emit a time signal after a predetermined or predeterminable time has elapsed. As has been explained above, a metering procedure can be executed with the metering device according to the invention specifically by the exertion of pressure pulses originating from the working chamber on the metering chamber. The aforementioned timing device is advantageous for achieving an as exact as possible time control of such a pressure surge.

In this connection it is particularly advantageous if the time after which the timing device emits a time signal can be adjusted, so that pressure surges of different, but predetermined or predeterminable duration, can be exerted by the working chamber on the metering chamber.

Since the second control device is designed to control the valve actuator, it is advantageously envisaged for the time control of the valve opening that the second control device is designed to switch the valve after a predetermined time has elapsed from a setting of the valve in the passage position to the blocking position, in response to a time signal of the timing device. Thus, a pressure surge of predetermined duration can be exerted in an automated manner on the metering chamber by the pressure reservoir provided in the working chamber, and a metering procedure can thereby be executed. The metering volume can in this connection be adjusted by the change in the time that elapses between the adjustment of the valve to the passage position and the adjustment of the valve to the blocking position.

It can furthermore be envisaged to store a characteristics map in a memory, which includes a matching of lengths of time to metering volumes, if necessary broken down further according to parameters of possible metering media such as density, viscosity and the like.

According to a further aspect of the present invention the object mentioned above is likewise solved by a generic metering method, which comprises the following further method step:
before the influencing of the pressure of the working medium in the metering chamber: interruption of any pressure transmission connection between a working chamber at least partially filled with the working medium and the metering chamber, the step of the influencing of the working medium pressure comprising the following further method steps:
bringing and/or maintaining the pressure of the working medium in the working chamber to a predetermined pressure level during the time any pressure transmission connection between the working chamber and the metering chamber is interrupted, and
while the pressure of the working medium in the working chamber is at the predetermined pressure level: opening a pressure transmission connection between the working chamber and the metering chamber.

By means of this method it is likewise made possible to provide in a working chamber a pressure reservoir that has a higher pressure than would be necessary and sufficient for aspirating and/or dispensing a predetermined metering volume that is very small in relation to the maximum possible metering volume, if there were no possibility of interrupting a pressure transmission connection between the working chamber and the metering chamber. Again, by maintaining the pressure transmission connection for a predetermined duration a pressure surge can be exerted by the working chamber on the metering chamber, whereby a very small metering volume in relation to the maximum possible metering volume can be aspirated and/or dispensed.

In order to generate pressure surges that are short in relation to the overall duration of the metering procedure, the method preferably comprises the following further step:
allowing a predetermined time to elapse from the opening of a pressure transmission connection between the working chamber and the metering chamber, and
interrupting any pressure transmission connection between the working chamber and the metering chamber after the predetermined time has elapsed.

In order to meter variously small metering volumes the method according to the invention can also include a selective adjustment of the duration envisaged to elapse.

In order to achieve as high a metering accuracy as possible it can moreover be envisaged that the influencing of the pressure of the working medium by the pressure change apparatus occurs exclusively when the valve is in the blocking position.

For a so-called aliquot metering, i.e. the dispensing of very small metering volumes that are as identical as possible, it is advantageous if the method is carried out iteratively, in other words the process steps including the interruption and the opening of the pressure transmission connection performed between the interruption of any pressure transmission connection and the opening of a pressure transmission connection between the working chamber and the metering chamber, are carried out repeatedly. Accordingly it can also be envisaged to aspirate first of all a very large metering volume of metering medium, corresponding to about the maximum possible metering volume, and then to release this successively in very many very small metering volumes by means of the metering method according to the invention. In this connection the metering device with which the metering method is carried out is preferably moved between two successive dispensing operations, so that the small metering volumes are delivered to different vessels. The precision of the metering procedures can also be increased if the pressure of the working medium in the working chamber is brought to a predetermined pressure level between the successive dispensing operations.

The present invention is illustrated in more detail hereinafter with the aid of the accompanying drawing. The drawing shows a diagrammatic representation of a metering device according to the invention.

In the FIGURE a metering device according to the invention is denoted generally by the reference numeral 10. The metering device 10 comprises a working chamber 12, which in the illustrated example contains air or another gas as working medium.

The working chamber 12 extends along a longitudinal axis L of the metering device 10 and is bounded in an axial direction by the front face 14a of a piston 14. The piston 14 is axially movably accommodated in a cylinder 16, whose cylinder wall 16a demarcates the working chamber 12 in the radial direction.

In order to change the volume of the working chamber 12 and thus change the pressure of the working medium contained in the working chamber 12, the piston 14 is coupled to a motor 18, which can be controlled via a control unit 20. For example, for this purpose a pinion can be mounted on an output shaft of a rotary electric motor, the pinion being torsionally fixedly connected to the output shaft of the motor and engaging with a rack-and-pinion assembly on the piston rod 14b.

A pipetting tip 22 is detachably coupled to the cylinder 16 in a manner known per se at its longitudinal end facing opposite the outlet end of the piston 14 and piston rod 14b. The pipetting tip 22 is a longitudinal structure, which in the state coupled to the cylinder 16 likewise extends along the longitudinal axis L of the metering device. The longitudinal axis of the pipetting tip 22 and the longitudinal axis of the cylinder 16 coincide when the pipetting tip is coupled, with the longitudinal axis L of the metering device 10 in the illustrated example.

The pipetting tip 22 defines in its interior a metering chamber 24, into which in the example illustrated in the FIGURE a liquid metering medium 26 was aspirated. In this context, the metering medium 26 has flown through the metering opening 22a of the pipetting tip 22 into the metering chamber 24.

A valve 28 supported in the cylinder 16 is axially located between the working chamber 12 and the metering chamber 24, which valve can be switched via a valve actuator 30, simply illustrated diagrammatically, between a passage position, in which the working chamber 12 and the metering chamber 24 communicate in a pressure-transmitting manner with one another, and a blocking position, in which the working chamber 12 is separated as regards flow from the metering chamber 24.

A pressure measuring instrument 32 is connected to the working chamber 12, which measures the pressure of the working medium in the working chamber 12. The pressure measuring instrument 32 transmits to the control 20 via a signal line 34 a signal indicating the pressure of the working medium in the working chamber 12.

A program is stored in the control 20, and operates the motor 18 via a control line 36 in order to drive the piston 14 so that in the working chamber 12 the working medium is at a predetermined pressure level. For this purpose the control 20 has previously operated the valve actuator 30 via the control line 38 so as to close the valve 28.

In the example illustrated in the FIGURE a relatively large amount of the metering medium 26 was aspirated into the pipetting tip 22. To this end the valve 28 was adjusted to the passage position and the piston 14 was displaced in the direction of an increase of the working chamber 12.

If now, as in a so-called “aliquoting”, the metering medium 26 aspirated into the pipetting tip 22 is to be dispensed in very small volumes in relation to the total volume of the aspirated metering medium 26, the valve 28 is for this purpose brought into the blocking position by means of the valve actuator 30 and the piston 14 is moved in the direction of a decrease in volume of the working chamber 12 so as to generate an excess pressure in relation to the ambient pressure in the surroundings of the metering opening 22a. The piston movement 14 lasts until the control 20 recognises on the basis of the output signal on the data line 34 that the pressure of the working medium in the working chamber 12 agrees with a predetermined target pressure. Following this the control 20 stops the operation of the motor 18, and thus holds the piston 14 at the point that has been reached.

The control 20, which comprises a timer 20a, then opens the valve 28 to dispense a very small metering volume of the metering medium 26 for a predetermined short period of time via the control line 38 and the valve actuator 30, i.e. adjusts the valve to the passage position. After the predetermined time has elapsed the control 20 controls the valve actuator 30 so as to adjust the valve 28 to the blocking position.

In this way an excess pressure surge is transmitted from the working chamber 12 to the metering chamber 24. This excess pressure surge provides for the discharge of a very small reproducible amount of metering medium 26 through the metering opening 22a. The metering volume, i.e. the amount of the dispensed metering medium 26, depends in this connection on the duration of the excess pressure surge. Accordingly the length of the excess pressure surge (in the same way as the duration of a reduced pressure surge in the case of aspiration) is preferably adjustable.

After the closure of the valve 28, i.e. after the adjustment to the blocking position, the control 20 regulates the pressure of the working medium in the working chamber 12 again in the aforedescribed manner to the desired target pressure, before a further dispensing procedure takes place, which is very largely identical to the procedure described hereinbefore. In the meantime the metering opening is moved relative to a titre plate, in order to release successive metering volumes into different containers.

The control 20 advantageously comprises a memory 20b, in which at least one characteristics map for different working media and/or different metering media and/or different state variables, such as temperature, pressure, viscosity and the like, can be stored, which couples desired metering volumes to target pressures of the working medium in the working chamber 12 and durations of the passage position of the valve 28. An operator can then easily input the employed working medium, the metering medium to be metered and the desired metering volume, if necessary state variables such as pressure, temperature and viscosity are to be input or these are detected in part by sensors not shown in the FIGURE, following which the desired metering proceeds automatically with a high degree of precision.

1. Metering device for aspirating and dispensing a metering medium (26) by means of a working medium through a metering opening (22a) into a metering chamber (24) and out of the latter, comprising:
a working chamber (12) at least partially filled with a compressible working medium,
a pressure change apparatus (14, 16) which is designed to change the pressure of the working medium in the working chamber (12), and
the metering chamber (24) comprising the metering opening (22a), characterised in that the working chamber (12) and the metering chamber (24) are connected via a valve (28), which can be switched between a blocking position, in which a pressure transmission, in particular a working medium flow, from the working chamber (12) via the valve (28) into the metering chamber (24) is prevented, and a passage position, in which a pressure transmission from the working chamber (12) via the valve (28) into the metering chamber (24) is permitted.

2. Metering device according to claim 1, characterised in that the pressure change apparatus (14, 16) is a piston-cylinder arrangement (14, 16), wherein preferably a piston surface (14a) and a cylinder wall (16a) demarcate at least sectionally the working chamber (12).

3. Metering device according to claim 1 or 2, characterised in that the metering chamber (24) is demarcated at least sectionally by a wall of a preferably detachable, particularly preferably exchangeable, pipetting tip (22).

4. Metering device according to claims 2 and 3, characterised in that the piston-cylinder arrangement (14, 16) is provided with a coupling arrangement, to which a coupling counter-arrangement provided on the pipetting tip (22) can be detachably coupled.

5. Metering device according to claim 4, characterised in that the piston-cylinder arrangement (14, 16) has in the region of the coupling arrangement a working medium passage, on which the valve (28) is provided.

6. Metering device according to claim 5, characterised in that the working medium passage comprises a first orifice terminating in the working chamber (12) and a second orifice lying more remote from the working chamber (12), wherein preferably a longitudinal end region of the working medium passage comprising the second orifice is surrounded at least by a section of the coupling arrangement.

7. Metering device according to claim 2, preferably with the inclusion of at least one of claims 3 to 6, characterised in that the valve (28) is arranged spatially between the piston (14) of the piston-cylinder arrangement (14, 16) and the metering opening (22a).

8. Metering device according to one of the preceding claims, characterised in that the pressure change apparatus (14, 16) comprises a pressure change actuator (18) for changing the pressure of the working medium in the working chamber (12) coupled to the pressure change apparatus (14, 16), and a first control device (20), wherein the first control device (20) is designed to control the pressure change actuator (18).

9. Metering device according to one of the preceding claims, characterised in that it comprises a valve actuator (30) for adjusting the valve (28) coupled thereto, and a second control device (20), which is designed to control the valve actuator (30).

10. Metering device according to one of the preceding claims, characterised in that it comprises a pressure detection device (32), which is designed and arranged so as to detect the pressure of the working medium in the working chamber (12).

11. Metering device according to claim 10, with the inclusion of claim 8, characterised in that the first control device (20) is designed so as to control the pressure change actuator (18) depending on the pressure detection result of the pressure detection device (32), and in particular is designed to generate and/or maintain a predetermined pressure of the working medium in the working chamber (12).

12. Metering device according to one of the preceding claims, with the inclusion of claim 9, characterised in that it comprises a timing device (20a), the second control device (20) preferably being designed to switch the valve (28) after a predetermined time has elapsed from a setting of the valve (28) in the passage position to the blocking position, in response to a time signal of the timing device (20a).

13. Metering method for aspirating and dispensing a metering medium by means of a working medium through a metering opening (22a) into a metering chamber (24) and out of the latter, comprising the following method steps:
influencing the pressure of the working medium in the metering chamber (24) relative to the ambient pressure outside the metering chamber (24),
characterised in that the method comprises the following further method step:
before the influencing of the pressure of the working medium in the metering chamber (24): interrupting any pressure transmission connection between a working chamber (12) at least partially filled with the working medium, and the metering chamber (24),
and in that the step of influencing the working medium pressure comprises the following further method step:
while any pressure transmission connection between the working chamber (12) and the metering chamber is interrupted, bringing and/or maintaining the pressure of the working medium in the working chamber (12) at a predetermined pressure level, and
while the pressure of the working medium in the working chamber (12) is at the predetermined pressure level: opening a pressure transmission connection between the working chamber (12) and the metering chamber (24).

14. Metering method according to claim 13, characterised in that it is carried out iteratively.
